(19) United States
(12) Patent Application Publication
(10) Pub. No.: US 2007/0025341 A1
(43) Pub. Date: Feb. 1, 2007

(54) Device, system and/or method for provisioning a device in a packet network

(75) Inventors: Steven Baigal, Clarksburg, MD (US); Shwu-Yan Chang Scoggins, Oak Hill, VA (US); Marian Stagarescu, Washington, DC (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/451,379

(22) Filed: Jun. 13, 2006

Related U.S. Application Data
(60) Provisional application No. 60/703,303, filed on Jul. 28, 2005.

(51) Int. Cl. H04L 12/66; H04J 1/00

(52) U.S. Cl. 370/352; 370/490

(57) ABSTRACT

A provisioning mechanism installed at a customer premise equipment (CPE) device capable of Voice over Packet (VoP) communication permits provisioning of the CPE device by an auto configuration server (ACS). The provisioning mechanism includes a Capabilities object associated with the CPE device, the Capabilities object including one or more of the following: one or more fax related parameters indicative of whether the CPE device supports fax related capabilities; and a ModemPassThrough parameter indicative of whether the CPE device supports modem pass through.

### CROSS-REFERENCE TO RELATED APPLICATIONS

This application claims the benefit of provisional application Ser. No. 60/703,303 filed 28 Jul. 2005, which is expressly incorporated herein by reference.

### TECHNICAL FIELD

The technical field relates generally to devices capable of voice communication over a communication network and devices and methods for managing such devices.

### BACKGROUND

A protocol exists for defining a provisioning mechanism for enabling provisioning of customer premise equipment (CPE) device by an Auto-Configuration Server (ACS). The protocol encompasses secure auto-configuration as well as other CPE management functions within a common framework and is specified by the TR-069 CPE WAN Management Protocol used by, for example, the DSL Forum governing body. The TR-069 CPE WAN Management Protocol is described in the publication entitled “TR-069 CPE WAN Management Protocol” produced by the DSL Home-Technical Working group on May of 2004 (hereafter “document 1”). The contents of this document are incorporated herein by reference. The provisioning mechanism defined by this protocol provides the CPE device with the ability to provision at the time of initial connection to an access network, and the ability to re-provision at any subsequent time. The protocol also provides the CPE device with tools to manage the CPE-specific components of optional applications or services.

As the use of CPE devices for voice communication over a packet network (VoP) continues to increase, it would be beneficial if an ability to manage VoP related parameters of the CPE device and additional VoP related features were also included as an extension to the TR-069 standard.

### SUMMARY

Accordingly, one or more embodiments of the present invention provide a provisioning mechanism installed at a customer premise equipment (CPE) device for permitting provisioning by an auto configuration server (ACS). The provisioning mechanism may be embodied in a computer readable medium that is installed at the CPE device. That is, the CPE device may be encoded with executable instructions representing a computer program as a result of the installation. The executable instructions or the computer readable medium result in the CPE device creating one or more instances of one or more objects related to Voice over Packet (VoP) communication for being provisioned by the ACS.

One or more embodiments of the present invention also provide a method of provisioning a CPE device capable of VoP communication. In the method, instances of one or more objects related to VoP communication are created.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present invention.

FIGS. 1A-1B are illustrations of exemplary network architectures in which a customer premise equipment device is provisioned by an auto-configuration server;

FIG. 2 is an illustration of the context in which an exemplary provisioning mechanism fits within the layered architecture of the open systems interconnection reference model (OSI model);

FIG. 3 is an illustration of an exemplary data model for the CPE parameters and objects; and

FIGS. 4A-4F are tables summarizing exemplary parameters and objects in a VoiceService object.

### DETAILED DESCRIPTION

In overview, the present disclosure concerns devices that communicate over communication networks, often referred to as packet switching networks. Such communication networks may provide services such as voice communications, data communications, video services, and/or gaming services and the like. More particularly, various inventive concepts and principles are embodied in systems, devices, and methods therein for providing a provisioning mechanism for provisioning of customer premise equipment (CPE) device capable of communication over a network. The provisioning may be performed by an Auto-Configuration Server (ACS). The communication may be performed over, for example, a Voice over Packet (VoP) network by using Asynchronous Transfer Mode (ATM) or by, for example, a Voice over Internet Protocol (VoIP) network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefor, and/or application specific ICs, or a combination thereof. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

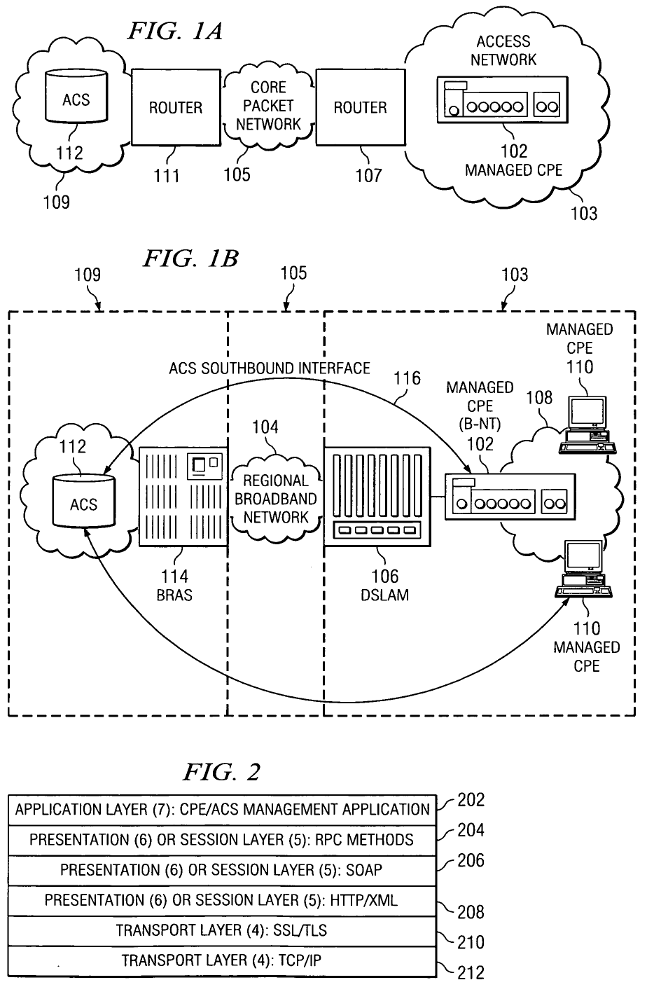

Referring to FIGS. 1A-1B, an exemplary environment in which a provisioning mechanism defined by a management protocol (Protocol), which defines parameters and objects for provisioning, can be implemented will be described.

An exemplary packet network architecture is shown in FIG. 1A. A customer premise equipment (CPE) device 102 within an access network 103 is connected to a core packet network 105 via a router 107. An auto-configuration server (ACS) 112 of a service provider 109 is connected to the core packet network 105 via a router 111. The CPE device 102 is managed by the ACS 112 via the connection with the core packet network 105.

In one example, the core packet network 105 may be, for example, a regional broadband network 104 as shown in FIG. 1B. In such a case, the CPE device 102 is connected to the regional broadband network 104 by, for example, a digital subscriber line access multiplexer (DSLAM) 106. The connection may be by, for example, Asymmetric Digital Subscriber Line (ADSL), Symmetric Digital Subscriber Line (SDSL), or very high bit-rate digital subscriber line (VDSL), xDSL as well as other technologies.

The CPE device 102 may be a broadband access CPE device (B-NT) defining a local area network (LAN) 108 to which other CPE devices, such as CPE devices 110, are connected. One or more devices capable of VoP communication such as, for example, VoIP, may be embedded within the B-NT 102. The other CPE devices 110 may be stand-alone routers, stand-alone voice over packet devices, LAN-side client devices, etc. The ACS 112 can be connected to the B-NT 102 or directly to one or more of the other CPE devices 110 by a broadband remote access server (BRAS) 114 via the regional broadband network 104. The connection between the B-NT 102 and the ACS 112 will be referred to as the ACS-Southbound Interface 116. The ACS 112 is a component in the broadband network responsible for auto-configuration and management of the B-NT 102.

The provisioning mechanism defined by the Protocol is preferably used on the ACS-Southbound Interface 116 between the ACS 112 and the CPE device 102 (B-NT) as shown. However, this Protocol may also be used to manage other types of CPE devices as well such as the stand-alone router, stand-alone VoP device and LAN-side client device as shown in FIG. 1B and discussed above. Unless otherwise indicated, the Protocol as defined here applies to any such managed device. Further, a CPE device that is either a B-NT or a broadband router may alternatively be referred to as an Internet Gateway Device.

Referring to FIG. 2, the context in which an exemplary provisioning mechanism defined by the Protocol fits within the layered architecture of the open systems interconnection reference model (OSI model) will be described. The CPE/ACS Application layer 202 uses the provisioning mechanism of the Protocol on the CPE device 102 and ACS 112. The application may be generally VoP or particularly, VoIP networks. The Remote Procedure Calls (RPC) Methods layer 204 refers to the specific RPC methods that are defined by the Protocol for performing the remote access methods. This includes the definition of the CPE Parameters accessible by the ACS 112 via parameter-related RPC Methods. The Simple Object Access Protocol (SOAP) layer 206 is a standard Extensible Markup Language (XML)-based syntax used here to encode remote procedure calls. Preferably, SOAP 1.1 is used.

The hypertext transfer protocol (HTTP) layer 208 is known. SOAP messages can be carried between the CPE device 102 and the ACS 112 using HTTP 1.1, where the CPE device 102 acts as the HTTP client and the ACS 112 acts as the HTTP server.

The Secure Socket Layer/Transport Layer Security (SSL/TLS) layer 210 includes standard Internet transport layer security protocols. Preferably, SSL/TLS is used to transport the parameters and objects defined by the provisioning mechanism of the Protocol, although the Protocol may instead be used directly over a TCP connection. If SSL/TLS is not used, some aspects of security are sacrificed. Specifically, SSL/TLS provides confidentiality and data integrity, and allows certificate-based authentication in lieu of shared secret-based authentication. Specifically, this layer may include either SSL 3.0 or TLS 1.0. Use of SSL/TLS is preferred but is not required. The TCP/IP layer 212 is known.

The Protocol will be further discussed with respect to the RPC Methods layer 204. An RPC mechanism is used for bi-directional communication between the CPE device 102 and the ACS 112. The specific procedure calls obtain or manipulate the value of one or more CPE parameters and objects. This includes both methods initiated by the ACS 112 and sent to the CPE device 102, as well as methods initiated by the CPE device 102 and sent to the ACS 112. As mentioned above, the Protocol preferably defines SOAP 1.1 as the encoding syntax to transport the RPC method calls and responses. However, the Protocol is independent of the syntax used to encode the RPC methods.

The Protocol includes a definition of the CPE parameter model for a CPE device 102 that is capable of VoIP communication or the B-NT that has (a) VoIP device(s) embedded therein. However, the Protocol is applicable to all VoP communication and is not limited to just VoIP.

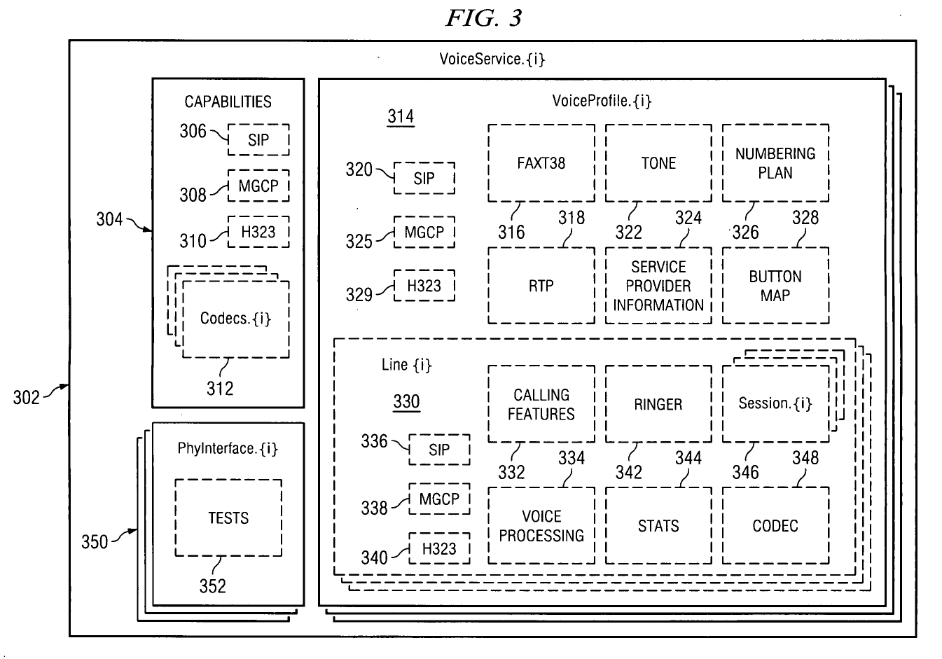

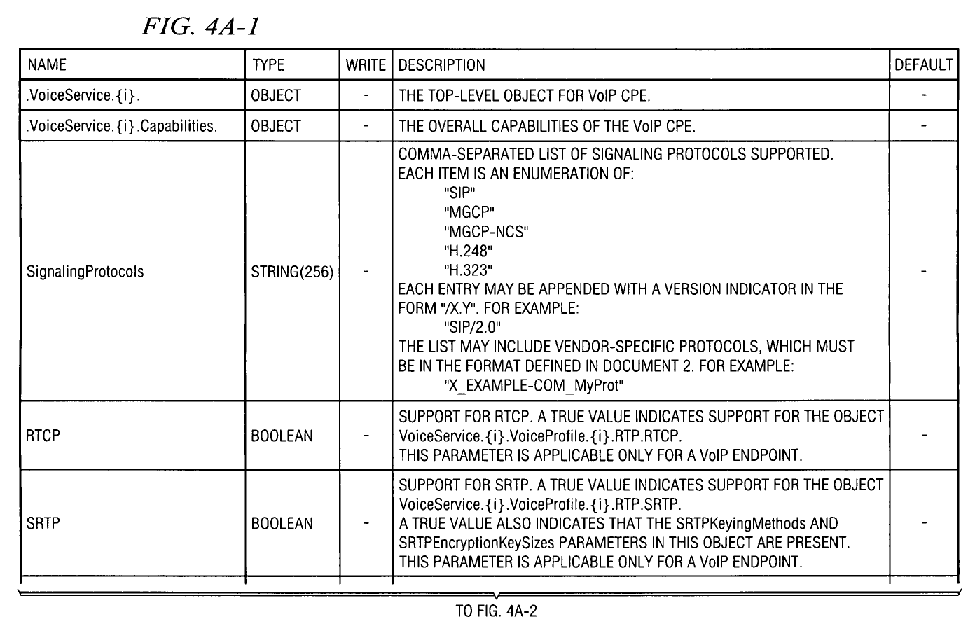

The data model of the CPE parameters and objects of the Protocol are shown in FIG. 3. Although an object may also be considered a parameter by those in the art, for sake of clarity, an object will be referred to here differently from the parameters. Particularly, an object will be defined as a collection of parameters and/or other objects for which multiples instances are defined. An object is similar to a container. An instance of an object may be created by the ACS 112 or the CPE device 102.

A parameter is a name-value pair representing a manageable CPE parameter made accessible to the ACS 112 for reading and/or writing. The parameters are accessible via RPC methods such as, for example, setting the parameter values, getting the parameter values, and getting the parameter names. A directory number is a distinct number by which a line is addressed. A line is a separately addressable voice line with one or more distinct Directory Numbers. An endpoint may be, for example, a VoIP device that acts as the initiation/termination point for VoIP calls, examples of which include VoIP phones and analog terminal adapters (ATAs). A profile is a group of lines with common characteristics. A session is a single active N-way (N is greater than or equal to two) voice media session. A single line may support more than one active session, for example, for CPE device provided three-way calling.

In the example shown in FIG. 3, parameter names use a hierarchical form similar to a directory tree. The name of a particular parameter is represented by the concatenation of each successive node in the hierarchy separated with a “.” (dot), starting at the trunk of the hierarchy and leading to the leaves. When specifying a partial path, indicating an intermediate node in the hierarchy, the trailing “.” (dot) is used as the last character. In some cases, where multiple instances of an object can occur, the placeholder node name “{i}” is shown. In actual use, this placeholder is to be replaced by an instance number, which must be a positive integer (≧1). Because in some cases object instances may also be deleted, instance numbers will in general not be contiguous. Optional or conditionally required objects are shown with a dashed border. Objects that for which there may be multiple instances are shown as overlapping layered blocks. Multiply instanced objects for which instances can be explicitly added or deleted are indicated with an asterisk (“*”).

Each of the parameters will be described with respect to an exemplary provisioning object for a CPE device 102. In this example, VoiceService is defined as a container associated with provisioning objects for a CPE device 102 capable of VoIP communication. That is, VoiceService object 302 is a top level service object representative of the CPE device 102. A CPE device 102 making use of a VoiceService object 302 preferably adheres to all of the data-hierarchy requirements defined in the DSL Forum TR-106 Data Model Template for TR-069-Enabled Devices described in the publication entitled “DSL Forum TR-106 Data Model Template for TR-069-Enabled Devices” produced by the DSL Home-Technical Working group on September of 2005 (hereafter “document 2”), the contents of which are incorporated by reference. In the context of document 2, the VoiceService object 302 defined in this specification is a Service Object. In the object structure for the VoiceService object 302 shown in FIG. 3, it should be noted that some of the sub-objects or parameters are not shown.

As defined in document 2, individual CPE devices 102 may include one or more instances of the VoiceService object 302, created by the CPE devices 102 itself or by the ACS 112 as a representation of the CPE device 102. The presence of more than one instances of the VoiceService object 302 might be appropriate, for example, when a CPE device 102 serves as a management proxy for other non-TR-069 capable CPE devices. For example, an Internet Gateway Device (a CPE device that is either a B-NT or a broadband router) might serve as a management proxy for one or more non-TR-069 capable VoIP phones.

The VoiceService object 302 includes a Capabilities object 304 associated with the CPE device 102. Although not shown in FIG. 3, the Capabilities object 304 includes one or more fax related parameters indicative of whether the CPE device 102 supports fax related capabilities and a ModemPassThrough parameter indicative of whether the CPE device 102 supports modem pass through. The one or more fax related parameters may be a FaxT38 parameter indicative of whether the CPE device 102 supports predetermined fax capabilities and a FaxPassThrough parameter indicative of whether the CPE device 102 supports fax pass through.

Although not specifically shown in FIG. 3, the Capabilities object 304 further includes a SignalingProtocols parameter defining a list of supported signaling protocols and a version of each of the supported signaling protocols, a real time transport control protocol (RTCP) parameter defining support for RTCP, wherein the RTCP parameter is applicable for endpoints, a secure real time transport protocol (SRTP) parameter defining support for SRTP, wherein the SRTP parameter is applicable for endpoints and an SRTPKeyingMethods parameter defining list of keying protocols supported by the endpoint for SRTP, and an SRTPEncryptionKeySizes parameter defining a list of list of supported SRTP encryption key sizes.

The Capabilities object 304 may further include an instance of a session initiation protocol (SIP) object 306, an instance of a Media Gateway Control Protocol (MGCP) object 308, an instance of an H323 object 310 and one or more instances of a Codecs object 312.

The instance of the SIP object 306 may include a TLSAuthenticationProtocols parameter defining a list of authentication protocols supported for transport layer security (TLS) transport, a TLSAuthenticationKeySizes parameter defining a list of supported TLS authentication key sizes, a TLSEncryptionProtocols parameter defining a list of authentication protocols supported for TLS transport, a TLSEncryptionKeySizes parameter defining a list of supported TLS encryption key sizes, a TLSKeyExchangeProtocols parameter defining a list of authentication protocols supported for TLS transport if the TLSEncryptionProtocols parameter in the capabilities object is present and includes at least one value other than NULL, and a DigitMap parameter indicating support for a configurable digit map string.

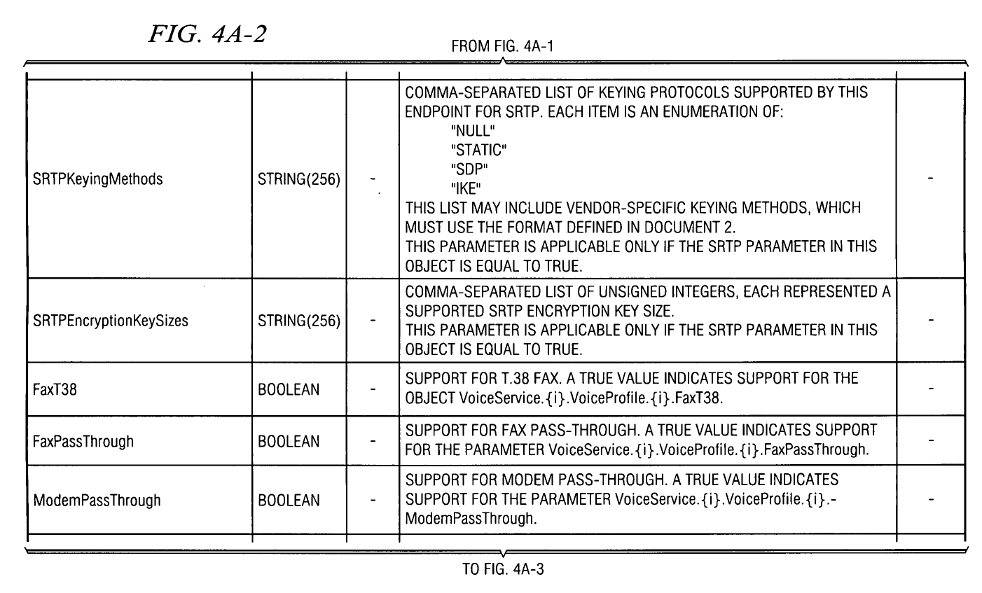

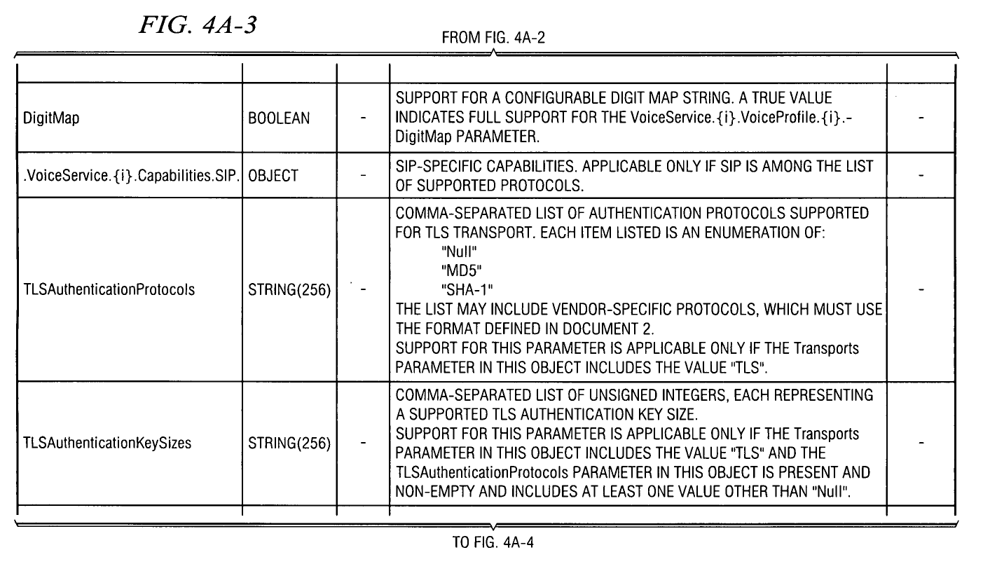

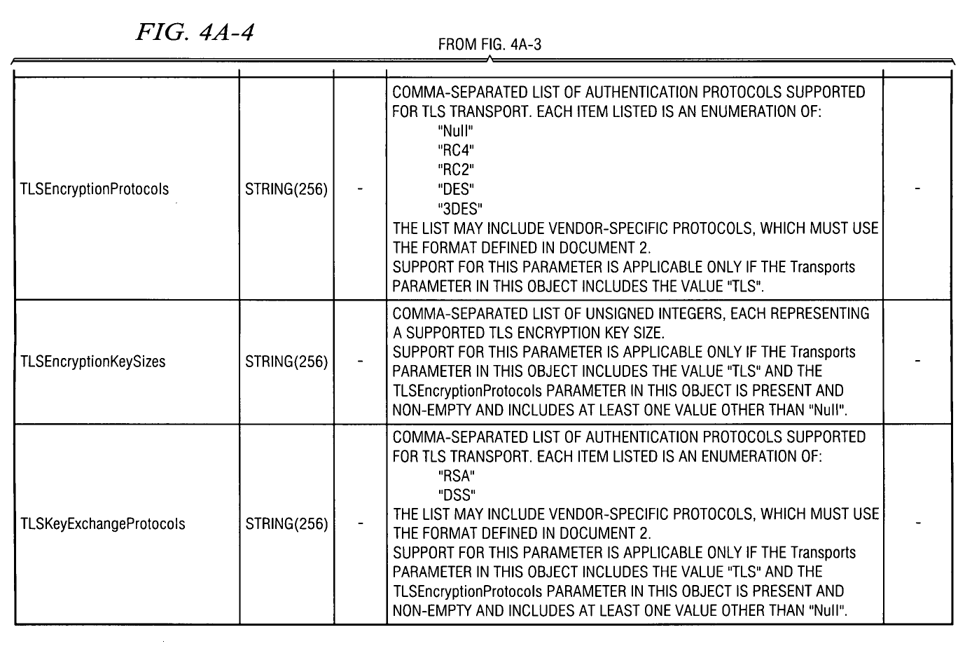

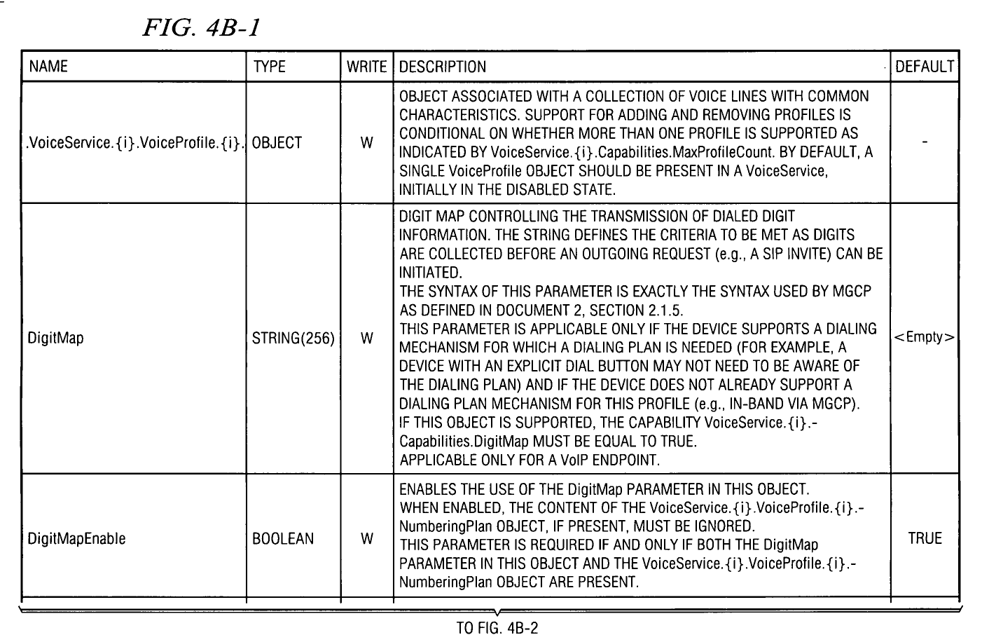

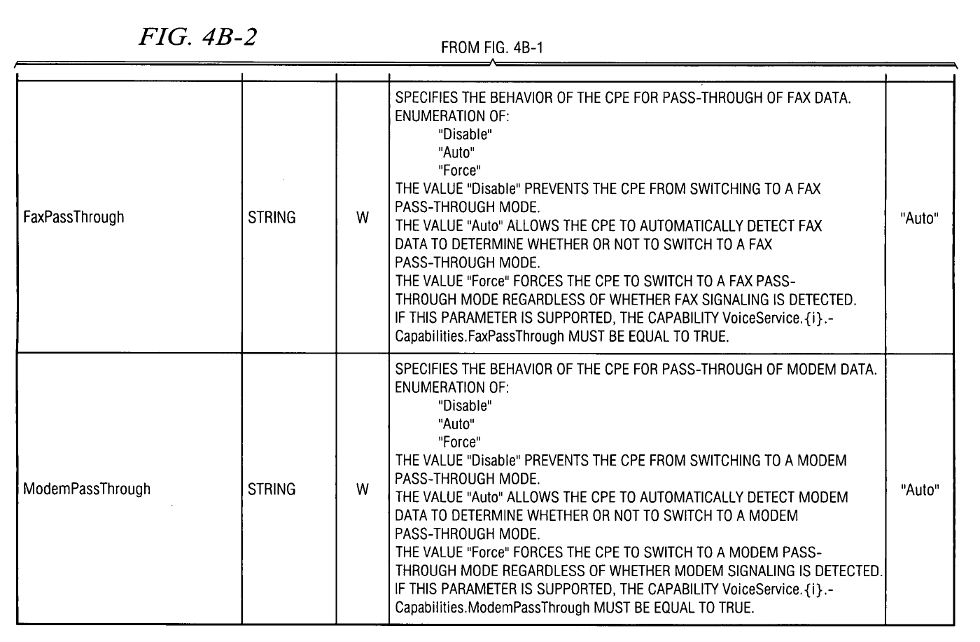

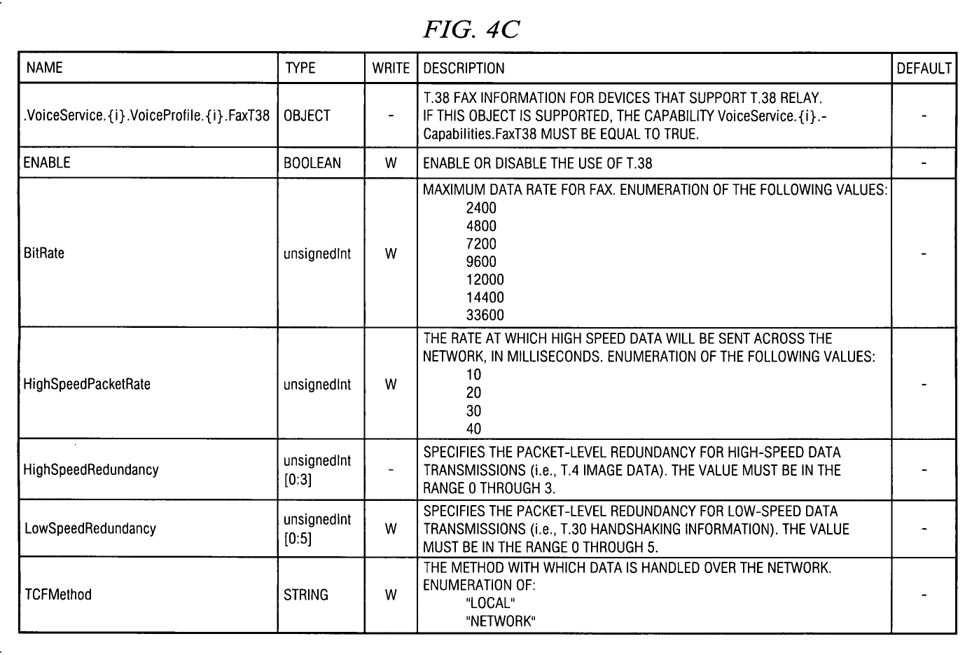

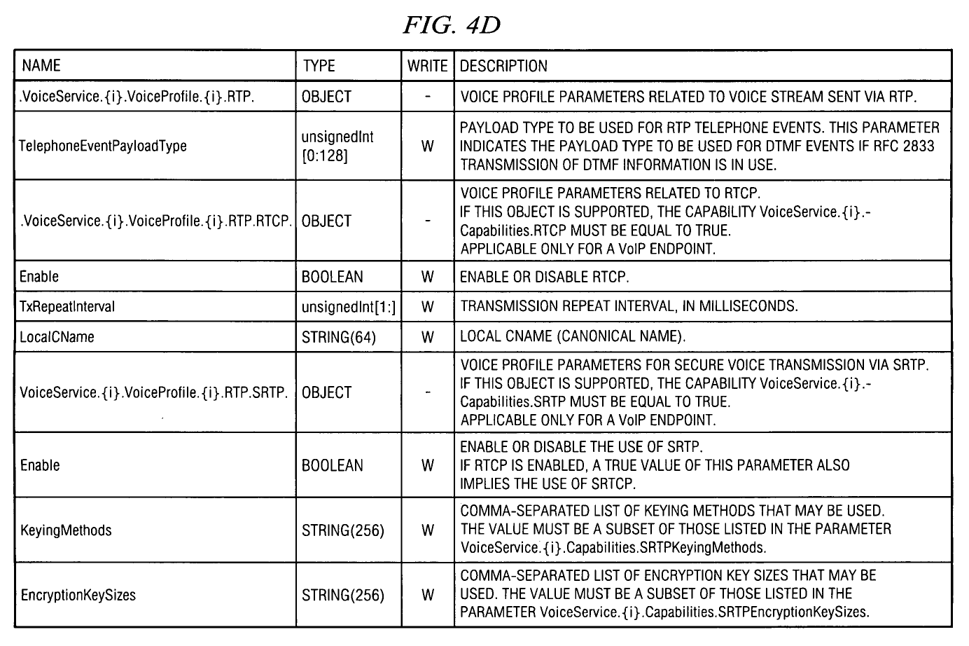

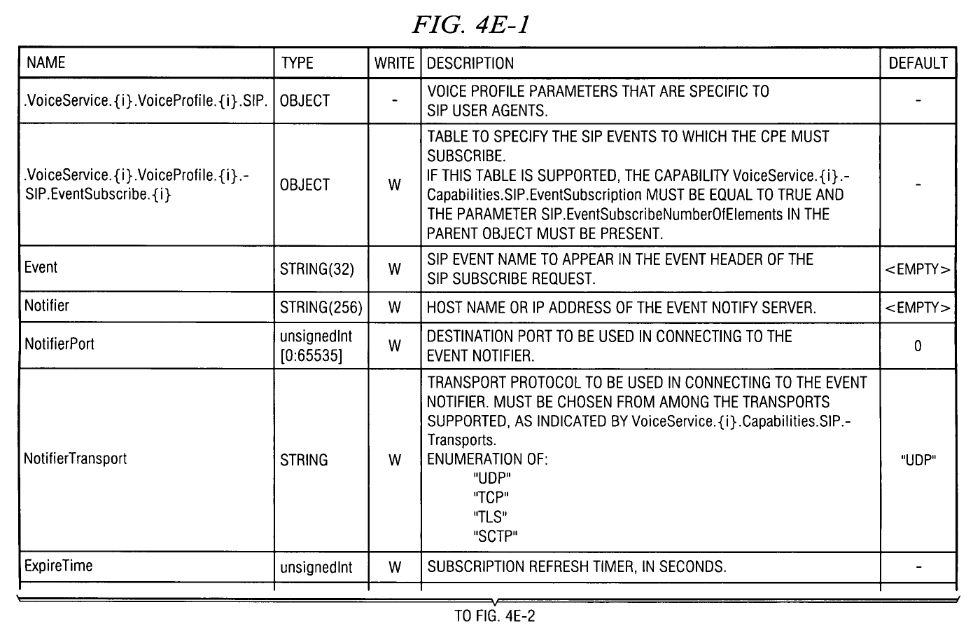

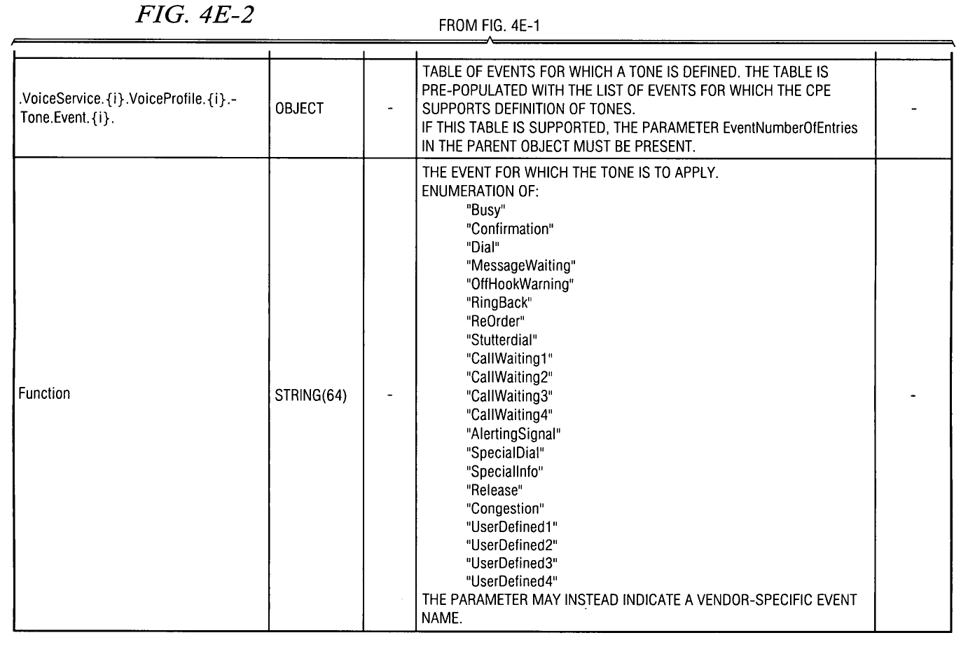

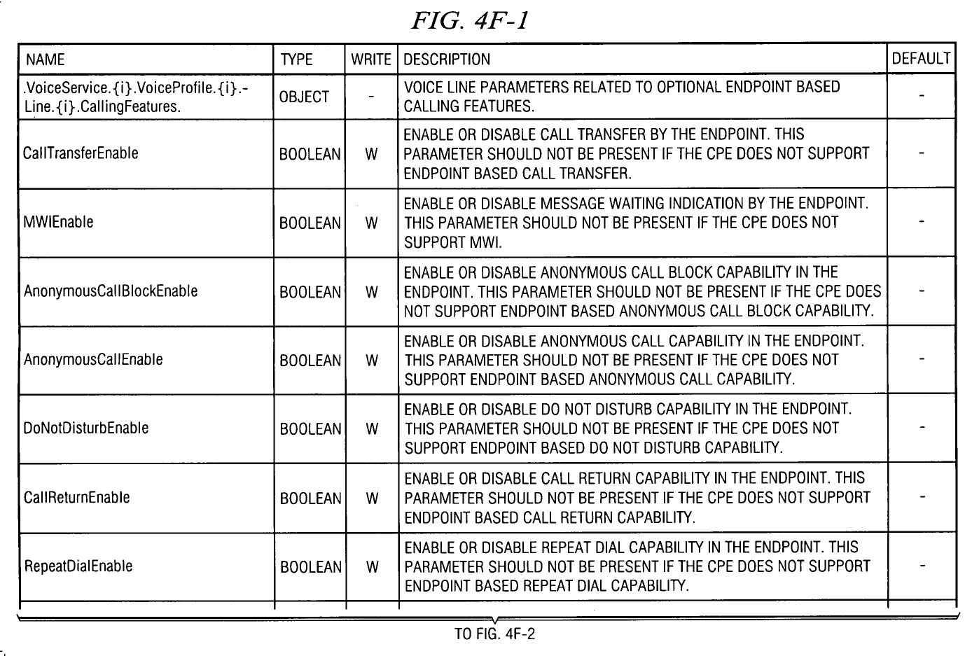

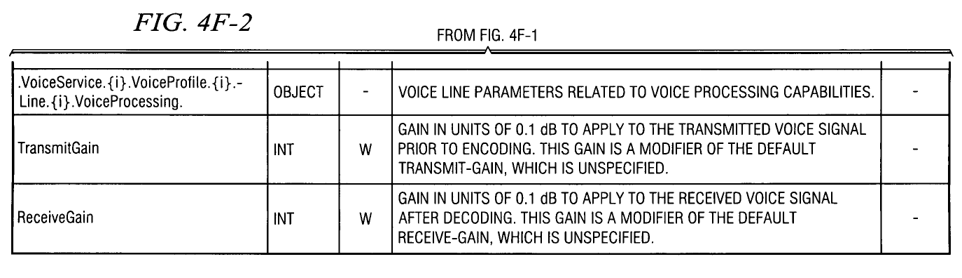

A summary of some of the parameters and objects that may be within the Capabilities object 304 is shown in FIG. 4A. In all of the tables shown in FIGS. 4A-4F, “Name” refers to the concatenation of the root object name with the parameter name. “Write” refers to whether or not the parameter is writable or read only. “Default” refers to the default value of the parameter after creation of an object instance.

Returning to FIG. 3, the voice service object 302 further includes one or more instances of a VoiceProfile object 314. Each of the instances of the VoiceProfile object 314 corresponds to one or more phone lines that share a similar basic configuration. Further, each instance of the VoiceProfile object 314 is associated with the CPE device 102.

The VoiceProfile object 314 is included in the model to allow a multi-line voice device to group lines with common characteristics under a single profile. By allowing more than one instance of the VoiceProfile object 314, the model allows a single multi-line voice device to have groups of lines that are configured differently from others. One possible use of this structure could be to associate distinct groups of lines with completely separate service providers, each with distinct VoIP servers and configuration requirements. Another possible use could be to distinguish between different levels of service from a single service provider. For example, a single device could provide some “consumer” lines plus some “business” lines, each associated with a distinct instance of the VoiceProfile object 314 distinguished by their quality characteristics. While the VoiceProfile object concept is in the defined model, the need to make use of it is completely optional.

The VoiceProfile object 314 itself includes a plurality of parameters and objects. Some of the parameters will be discussed below.

The VoiceProfile object 314 includes a voiceprofileFaxPassThrough parameter for specifying the behavior of the CPE device 102 for passing through fax data and a ModemPassThrough parameter for specifying the behavior of the CPE device 102 for passing through of modem data. It should be noted that the FaxPassThrough parameter included within the Capabilities object should be equal to TRUE when the CPE device 102 supports the voiceprofileFaxPassThrough parameter and that the ModemPassThrough Parameter included within the Capabilities object should be equal to TRUE when the CPE device 102 supports the ModemPassThrough parameter.

The VoiceProfile object 314 further includes a voiceprofileDigitMap parameter representative of a digit map for controlling transmission of dialed digit information and a voiceprofileDigitMapEnable parameter for enabling the use of the DigitMap parameter in the CPE device 102.

A summary of some of the top level parameters in the VoiceProfile object 314 is shown in FIG. 4B. The top level objects in the VoiceProfile object 314 are discussed below.

The VoiceProfile object 314 may include a FaxT38 object (a fax object) 316, which includes a plurality of voiceprofileFaxT38 parameters corresponding to FaxT38 information at, for example, an endpoint. The FaxT38 object 316 provides information for devices that support T.38 relay. It should be noted that the FaxT38 parameter within the Capabilities object 304 should be equal to TRUE when the CPE device 102 supports the FaxT38 object 316. Support or non-support of the FaxT38 object 316 is indicated by a fax enable parameter, which is enabled if the fax capability parameter indicates that a phone line associated with the CPE device 102 is capable of receiving facsimile transmission.

The plurality of voiceprofileFaxT38 parameters includes a maximum data rate parameter (BitRate parameter) indicating a maximum data rate for a facsimile transmission, a high speed data parameter (HighSpeedPacketRate parameter) indicating a rate at which high speed data will be sent across a network connection with the CPE device 102, a high-speed packet-level redundancy parameter (HighSpeedRedundancy parameter) indicating a packet-level redundancy for high-speed data transmission, a low-speed packet-level redundancy parameter (LowSpeedRedundancy parameter) indicating a packet-level redundancy for low-speed data transmission, and a handling method parameter (transparent computer facility Method parameter) specifying a handling method for data over the network. The FaxT38 object 316 also may include a PacketizationPeriod parameter indicative of supported packetization periods. A summary of some of the parameters in the FaxT38 object 316 is shown in FIG. 4C.

The VoiceProfile object 314 may include an instance of a real-time transport protocol (RTP) object 318 for voice profile parameters related to the voice stream sent via RTP. The RTP object 318 preferably includes a TelephoneEventPayloadType parameter indicative of payload type to be used for dual tone multifrequency (DTMF) events if remote function call (RFC) 2833 transmission of DTMF information is used.

The RTP object 318 also includes an instance of a real time transport control protocol (RTCP) object defining support for RTCP. The RTCP object 318 includes one or more RTCP parameters such as, for example, an enable parameter for enabling or disabling RTCP, a TxRepeatInterval parameter indicating the transmission repeat interval and a LocalCName parameter.

The RTP object 318 also includes an instance of a secure real time transport protocol (SRTP). The SRTP object includes parameters for secure voice profile parameters, such as, for example, an SRTP parameter indicative of whether SRTP and secure real time transport control protocol (SRTCP) are enabled, a KeyingMethods parameter indicative of a list of usable keying methods, and an EncryptionKeySizes parameter indicative of a list of usable encryption key sizes. A summary of some of the parameters and objects in the RTP object 316 is shown in FIG. 4D.

Each instance of the VoiceProfile object 314 includes an instance of a SIP object 320, which includes voice profile parameters that are specific to SIP user agents. The SIP object 320 includes an EventSubscribe object, which includes a plurality of SIP Event subscription parameters such as, for example, an Event parameter indicative of an event name to appear in a header of an SIP subscribe request, a Notifier parameter indicative of a Host name or Internet Protocol (IP) address of an event notify server, a NotifierPort parameter indicative of a destination port to be used in connecting to the event notify server, a NotifierTransport parameter indicative of the transport protocol to be used in connecting to the event notify server, and an ExpireTime parameter indicative of a subscription refresh time.

Each instance of the VoiceProfile object 314 may include an instance of a Tone object 322, which includes a string representative of a table of events for which a tone is defined, wherein the table is pre-populated with a list of events for which the CPE device 102 supports definition of tones. The Tone object 322 includes a Function parameter indicative of the event for which a tone is to apply.

A summary of some of the parameters and objects in the SIP object 320 and the Tone object 322 is shown in FIG. 4E.

The VoiceProfile object 314 may also include instances of a Service Provider Info object 324, a MGCP object 325, a Numbering Plan object 326, a Button Map object 328 and an H323 object 329.

Each instance of the VoiceProfile object 314 may include one or more instances of a Line object 330. As mentioned above, the VoiceProfile object 314 corresponds to one or more phone lines sharing a similar basic configuration. The Line object 330 is associated with a distinct voice line of the one or more phone lines. The Line object 330 includes a CallingFeatures object 332, which includes voice line parameters related to optional endpoint based calling features and that are independent of a protocol of the voice line. The voice line parameters may include a CallTransferEnable parameter indicative of whether to enable or disable call transfer by the endpoint, a message waiting indication (MWI) Enable parameter indicative of whether to enable or disable MWI by the endpoint, an AnonymousCallBlockEnable parameter indicative of whether to enable or disable Anonymous Call Block capability in the endpoint, an AnonymousCallEnable parameter indicative of whether to enable or disable Anonymous Call capability in the endpoint, a DoNotDisturbEnable parameter indicative of whether to Enable or disable Do Not Disturb capability in the endpoint, a CallReturnEnable parameter indicative of whether to Enable or disable Call Return capability in the endpoint, and a RepeatDialEnable parameter indicative of whether to Enable or disable Repeat Dial capability in the endpoint.

The Line object 330 may also include a Voice Processing Object 334, which includes voice line parameters related to voice processing capabilities. The Voice Processing Object may include a TransmitGain parameter indicative of gain to apply to a transmitted voice signal prior to encoding and a ReceiveGain parameter indicative of gain to apply to a received voice signal after decoding.

The Line object 320 may further include instances of an SIP object 336, an MGCP object 338, an H323 object 340, a Ringer object 342, a Stats object 344, a Session object 346 and a Codec object 348.

A summary of some of the parameters in the CallingFeatures and Voice Processing Objects 332, 334 is shown in FIG. 4F.

VoiceService 302 also includes one or more instances of a PhyInterface object 350. Each instance is associated with a distinct physical Foreign Exchange Station (FXS) port and is statically created by the CPE device 102. The PhyInterface object includes an instance of a Tests object 352 for voice port tests.

In the object structure for the VoiceService object 302, the only protocol-specific objects described are for SIP, MGCP, and H.323. However, the object structure allows for the possibility of parallel objects for other call-control protocols, such as, for example, H.248.

Returning to FIGS. 1A-1B, operation of the CPE device 102 (and/or 110), particularly of the provisioning mechanism defined by the Protocol will be briefly discussed. The provisioning mechanism may be embodied in a computer readable medium that is installed on the CPE device 102. For example, the provisioning mechanism may be embodied within a computer program that is compiled and installed on the CPE device 102 or it may be a hardware element installed thereon. At the time the managed CPE device 102 initially connects to a core packet network 105, such as, for example, the regional broadband network 104, provisioning is performed by the provisioning mechanism. Here, one or more instances of the top level object (VoiceService) representative of the CPE device 102 are created (instantiated) along with the sub-objects and parameters (generally CPE parameters) shown in FIG. 3 and discussed above and stored at a memory source associated with the CPE device 102. The values of each of the parameters of the various objects are determined based upon the capabilities of the CPE device 102. Further, if the CPE device 102 is an Internet Gateway Device that manages other CPE devices, such as, for example, CPE devices 110, the CPE device 102 will, assign different instances of voice service object for each managed CPE 110. During provisioning, the ACS 112 is able to read the values of the objects and parameters within the CPE device 102. The operation performed by the provisioning mechanism can also be performed at any later time such as during reprovisioning or power up.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A provisioning mechanism defined by a management protocol, the provisioning mechanism embodied in a computer readable medium installed at a customer premise equipment (CPE) device capable of Voice over Packet (VoP) communication, the provisioning mechanism permitting provisioning of the CPE device by an auto configuration server (ACS), the provisioning mechanism comprising:
a Capabilities object associated with the CPE device, the Capabilities object including one or more of the following:
one or more fax related parameters indicative of whether the CPE device supports fax related capabilities; and
a ModemPassThrough parameter indicative of whether the CPE device supports modem pass through.

2. The provisioning mechanism of claim 1, wherein the one or more fax related parameters further comprises a FaxT38 parameter indicative of whether the CPE device supports predetermined fax capabilities and a FaxPassThrough parameter indicative of whether the CPE device supports fax pass through.

3. The provisioning mechanism of claim 2, further comprising:
a voice profile object associated with the CPE device; and
a FaxT38 object included within the voice profile object, the FaxT38 object including a plurality of voiceprofileFaxT38 parameters corresponding to FaxT38 information at a VoP endpoint,
wherein the FaxT38 parameter is equal to TRUE when the CPE device supports the FaxT38 object.

4. The provisioning mechanism of claim 2, further comprising:
a voiceprofileFaxPassThrough parameter included within the voice profile object;
wherein the FaxPassThrough parameter included within the Capabilities object is equal to TRUE when the CPE device supports the voiceprofileFaxPassThrough parameter.

5. The provisioning mechanism of claim 3, wherein the plurality of voiceprofileFaxT38 parameters includes one or more of the following:
a maximum data rate parameter indicating a maximum data rate for a facsimile transmission;
a high speed data parameter indicating a rate at which high speed data will be sent across a network connection with the CPE device;
a high-speed packet-level redundancy parameter indicating a packet-level redundancy for high-speed data transmission;
a low-speed packet-level redundancy parameter indicating a packet-level redundancy for low-speed data transmission; and
a handling method parameter specifying a handling method for data over the network connection.

6. The provisioning mechanism of claim 1, wherein the Capabilities object further includes one or more of the following:
a SignalingProtocols parameter defining a list of supported signaling protocols;
a real time transport control protocol (RTCP) parameter defining support for RTCP, wherein the RTCP parameter is applicable for VoP endpoints;
a secure real time transport protocol (SRTP) parameter defining support for SRTP, wherein the SRTP parameter is applicable for VoP endpoints;
an SRTPKeyingMethods parameter defining list of keying protocols supported by an endpoint for SRTP;
an SRTPEncryptionKeySizes parameter defining a list of list of supported SRTP encryption key sizes;
a TLSAuthenticationProtocols parameter defining a list of authentication protocols supported for transport layer security (TLS) transport;
a TLSAuthenticationKeySizes parameter defining a list of supported TLS authentication key sizes;
a TLSEncryptionProtocols parameter defining a list of authentication protocols supported for TLS transport;
a TLSEncryptionKeySizes parameter defining a list of supported TLS encryption key sizes; and
a TLSKeyExchangeProtocols parameter defining a list of authentication protocols supported for TLS transport only if the TLSEncryptionProtocols parameter in the Capabilities object is present and includes at least one value other than NULL.

7. The provisioning mechanism of claim 1, further comprising:
a DigitMap parameter indicating support for a configurable digit map string within the Capabilities object;
a voice profile object associated with the CPE device, wherein the voice profile object includes:
a voiceprofileDigitMap parameter representative of a digit map for controlling transmission of dialed digit information; and
a voiceprofileDigitMapEnable parameter for enabling use of the DigitMap parameter in the CPE device.

8. A method of permitting provisioning of a customer premise equipment (CPE) device capable of Voice over Packet (VoP) communication, the method comprising:
creating an instance of a top level service object representative of the CPE device, the top level service object including one or more CPE parameters, wherein the one or more CPE parameters includes one of:
a fax capability parameter indicative of whether a phone line associated with the CPE device is capable of receiving facsimile transmission;
a FaxPassThrough parameter indicative of whether the phone line associated with the CPE device is capable of supporting fax pass-through; and
a ModemPassThrough parameter indicative of whether the phone line associated with the CPE device is capable of supporting modem pass through.

9. The method of claim 8, further comprising creating an instance of a voice service capability object within the instance of the top level service object, the voice service capability object including the one or more CPE parameters.

10. The method of claim 9, further comprising:
creating an instance of a voice profile object within the top level service object, the voice profile object corresponding to one or more phone lines sharing a similar basic configuration, the voice profile object including:
an instance of a fax object within the voice profile object, the fax object including a fax enable parameter, wherein the fax enable parameter is enabled if the fax capability parameter indicates that the phone line associated with the CPE device is capable of receiving facsimile transmission;
a voiceprofileFaxPassthrough parameter specifying fax pass through behavior of the CPE device; and
a voiceprofileModemPassThrough parameter specifying modem pass through behavior of the CPE device.

11. The method of claim 10, wherein the instance of the fax object further includes a PacketizationPeriod parameter indicative of supported packetization periods.

12. The method of claim 8, wherein the one or more CPE parameters further includes a SignalingProtocols parameter indicative of supported signaling protocols and a version of each of the supported signaling protocols.

13. The method of claim 8, wherein the creating the instance of the top level service object further comprises creating an instance of a voice profile object within the top level service object, the voice profile object corresponding to one or more phone lines sharing a similar basic configuration, the voice profile object comprising:
an instance of a real-time transport protocol (RTP) object within the voice profile object, the RTP object being for voice profile parameters related to the voice stream sent via RTP, wherein the RTP object includes a TelephoneEventPayloadType parameter indicative of payload type to be used for dual tone multifrequency (DTMF) events if remote function call (RFC) 2833 transmission of DTMF information is used.

14. The method of claim 8, wherein the creating the instance of the top level service object further comprises creating an instance of a voice profile object within the top level service object, the voice profile object corresponding to one or more phone lines sharing a similar basic configuration, the method further comprising:
creating an instance of a real time protocol (RTP) object within the voice profile object, the RTP object including voice profile parameters related to a voice stream sent via RTP, wherein the RTP object includes a real time transport control protocol (RTCP) object, wherein the RTCP object includes one or more RTCP parameters.

15. The method of claim 14, further comprising creating an instance of a secure real time transport protocol (SRTP) object within the voice profile object, wherein the SRTP object includes an SRTP parameter indicative of whether SRTP and secure real time transport control protocol (SRTCP) are enabled, a KeyingMethods parameter indicative of a list of usable keying methods, and an EncryptionKeySizes parameter indicative of a list of usable encryption key sizes.

16. The method of claim 8, further comprising:
creating an instance of a voice profile object within the top level service object, the voice profile object corresponding to one or more phone lines sharing a similar basic configuration; and
creating an instance of a Line object within the voice profile object, the Line object being associated with a distinct voice line, wherein the Line object includes a CallingFeatures object, the CallingFeatures object including voice line parameters related to optional endpoint based calling features, the voice line parameters being independent of a protocol of the voice line, wherein the voice line parameters include one or more of the following:
a CallTransferEnable parameter indicative of whether to enable or disable call transfer by an endpoint; a message waiting indication (MWI) Enable parameter indicative of whether to enable or disable MWI by the endpoint; an AnonymousCallBlockEnable parameter indicative of whether to enable or disable Anonymous Call Block capability in the endpoint; an AnonymousCallEnable parameter indicative of whether to enable or disable Anonymous Call capability in the endpoint; a DoNotDisturbEnable parameter indicative of whether to Enable or disable Do Not Disturb capability in the endpoint; a CallReturEnable parameter indicative of whether to Enable or disable Call Return capability in the endpoint; and a RepeatDialEnable parameter indicative of whether to Enable or disable Repeat Dial capability in the endpoint.

17. The method of claim 8, further comprising:
creating an instance of a voice profile object within the top level service object, the voice profile object corresponding to one or more phone lines sharing a similar basic configuration; and
creating an instance of a session initiation protocol (SIP) object within the voice profile object, the SIP object including voice profile parameters that are specific to SIP user agents, wherein the SIP object includes an EventSubscribe object, the EventSubscribe object including a plurality of SIP Event subscription parameters including one or more of the following:
an Event parameter indicative of an event name to appear in a header of an SIP subscribe request;
a Notifier parameter indicative of a Host name or Internet Protocol (IP) address of an event notify server;
a NotifierPort parameter indicative of a destination port to be used in connecting to the event notify server;
a NotifierTransport parameter indicative of the transport protocol to be used in connecting to the event notify server; and
an ExpireTime parameter indicative of a subscription refresh time.

18. The method of claim 8, wherein the instance of the top level service object further includes one or more of the following:
a real time transport control protocol (RTCP) parameter indicative of support for RTCP;
a secure real time transport protocol (SRTP) parameter indicative of support for SRTP;
an SRTPKeyingMethods representative of a list of keying protocols supported by an endpoint for SRTP;
an SRTPEncryptionKeySizes parameter indicative of supported SRTP encryption key sizes; and
a DigitMap parameter indicative of support for a configurable digit map string.

19. The method of claim 8, further comprising:
creating an instance of a session initiation protocol (SIP) object within the top level object, the SIP object for specifying SIP-specific capabilities, the SIP object including one or more of the following parameters:
a TLSAuthenticationProtocols parameter defining a list of authentication protocols supported for transport layer security (TLS) transport;
a TLSAuthenticationKeySizes parameter defining a list of supported TLS authentication key sizes;
a TLSEncryptionProtocols parameter defining a list of authentication protocols supported for TLS transport;
a TLSEncryptionKeySizes parameter defining a list of supported TLS encryption key sizes; and
a TLSKeyExchangeProtocols parameter defining a list of authentication protocols supported for TLS transport.

20. The method of claim 8, further comprising:
creating an instance of a voice profile object within the top level service object, the voice profile object corresponding to one or more phone lines sharing a similar basic configuration, the voice profile object including one or more of the following parameters:
a DigitMap parameter representative of a digit map for controlling transmission of dialed digit information; and
a DigitMapEnable parameter for enabling use of the DigitMap parameter in the CPE device.

21. The method of claim 8, further comprising:
creating an instance of a voice profile object within the top level service object, the voice profile object corresponding to one or more phone lines sharing a similar basic configuration; and
creating an instance of a Tone object within the voice profile object, the Tone object representative of a table of events for which a tone is defined, wherein the table is pre-populated with a list of events for which the CPE device supports definition of tones, the Tone object including a Function parameter indicative of an event for which a tone is to apply.

22. The method of claim 8, further comprising:
creating an instance of a FaxT38 object, the FaxT38 object being for providing information for devices that support T.38 relay; the FaxT38 object including one or more of the following parameters:
a BitRate parameter indicative of a maximum data rate for fax;
a HighSpeedPacketRate parameter indicative of rate at which high speed data will be sent across a network;
a HighSpeedRedundancy parameter for specifying a packet-level redundancy for high-speed data transmissions;
a LowSpeedRedundancy parameter for specifying the packet-level redundancy for low-speed data transmissions; and
a transparent computer facility (TCF) Method parameter for specifying the method with which data is handled over the network.

23. The method of claim 8, further comprising:
creating an instance of a voice profile object within the top level service object, the voice profile object corresponding to one or more phone lines sharing similar basic configuration; and
creating an instance of a Line object within the voice profile object, the Line object being associated with a distinct voice line, wherein the Line object includes a Voice Processing Object for voice line parameters related to voice processing capabilities, wherein the Voice Processing Object includes a TransmitGain parameter indicative of gain to apply to a transmitted voice signal prior to encoding and a ReceiveGain parameter indicative of gain to apply to a received voice signal after decoding.

24. A packet network architecture comprising:
an access network comprising a customer premise equipment (CPE) device and having a connection with a core packet network, the CPE device being configured to include a provisioning mechanism, the provisioning mechanism comprising:
an instance of a top level service object representative of the CPE device, the top level service object including one or more CPE parameters accessible to an auto-configuration-server (ACS), wherein the one or more CPE parameters includes one of:
a fax capability parameter indicative of whether a phone line associated with the CPE device is capable of receiving facsimile transmission;
a FaxPassThrough parameter indicative of whether the phone line associated with the CPE device is capable of supporting fax pass-through; and
a ModemPassThrough parameter indicative of whether the phone line associated with the CPE device is capable of supporting modem pass through.

25. The packet network architecture of claim 24, wherein the access network further comprises a plurality of CPE devices managed by the CPE device configured to include the provisioning mechanism.

26. A packet network comprising:
an auto-configuration-server (ACS); and
an Internet Gateway Device capable of voice communication over a voice over packet (VoP) network connection, the Internet Gateway Device managing one or more customer premise equipment (CPE) devices based upon a connection with the ACS;
wherein the Internet Gateway Device comprises one or more instances of a top level service object representative of the one or more CPE devices, respectively, the top level service object including one or more CPE parameters accessible to the ACS, wherein the one or more CPE parameters includes one of:
a fax capability parameter indicative of whether a phone line associated with a particular one of the one or more CPE devices is capable of receiving facsimile transmission;
a FaxPassThrough parameter indicative of whether the phone line associated with the particular one of the one or more CPE devices is capable of supporting fax pass-through; and
a ModemPassThrough parameter indicative of whether the phone line associated with the particular one of the one or more CPE devices is capable of supporting modem pass through.

27. The packet network of claim 26, wherein the Internet Gateway Device has a broadband connection with a regional broadband network.

28. A computer premise equipment (CPE) device capable of voice over packet (VoP) communication over a network, the CPE device encoded with executable instructions representing a computer program, the computer program resulting in the CPE device being capable of:
creating an instance of a top level service object representative of the CPE device, the top level service object including one or more CPE parameters, wherein the one or more CPE parameters includes one of:
a fax capability parameter indicative of whether a phone line associated with the CPE device is capable of receiving facsimile transmission;
a FaxPassThrough parameter indicative of whether the phone line associated with the CPE device is capable of supporting fax pass-through; and
a ModemPassThrough parameter indicative of whether the phone line associated with the CPE device is capable of supporting modem pass through.

29. The CPE device of claim 28, wherein the computer program further results in the CPE device being capable of creating an instance of a voice service capability object within the instance of the top level service object, the voice service capability object including the one or more CPE parameters.
